(19) United States
(12) Patent Application Publication
(10) Pub. No.: US 2008/0153519 A1
(43) Pub. Date: Jun. 26, 2008

(54) Conducting sessions initiated from non-mobile terminals

(75) Inventors: Kari Silfverberg, Mouhijarvi (FI); Mikko Ruhanen, Tampere (FI); Petri Aalto, Pirkkala (FI)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: Nokia Corporation

(21) Appl. No.: 11/642,555

(22) Filed: Dec. 21, 2006

(51) Int. Cl. H04Q 7/20

(52) U.S. Cl. 455/466

(57) ABSTRACT

A method includes receiving a message regarding the initiation of a session from a non-mobile terminal, and making a request for subscriber profile information for the non-mobile terminal to a register that is also configured to receive requests for subscriber profile information for mobile terminals. The session is controlled on the basis of subscriber profile information for the non-mobile terminal received in reply to the request.

The present invention relates to a new technique for conducting a session initiated at a non-mobile terminal. In one embodiment, the session is initiated from a Public Switched Telephone Network (PSTN) terminal.

Conventionally, sessions initiated at PSTN terminals are usually conducted via one or more PSTN switch/telephone exchanges.

It is an aim of the present invention to provide an alternative technique for conducting sessions initiated at non-mobile terminals.

The term “non-mobile terminal” is used in this specification to distinguish over mobile terminals such as GSM wireless terminals, which are typically used to initiate sessions from widely different locations. The term “non-mobile terminal” includes, for example, a PSTN user terminal that is connected to the PSTN by a fixed line by which it is identified and which may be wirelessly connected within a limited area, such as a home or office etc., to one or more user handsets to allow a user to conveniently access the PSTN terminal from different locations within the limited area.

According to the present invention, there is provided a method comprising: receiving a message regarding the initiation of a session from a non-mobile terminal; making a request for subscriber profile information for said non-mobile terminal to a register that is also configured to receive requests for subscriber profile information for mobile terminals; and controlling said session on the basis of subscriber profile information for said non-mobile terminal received in reply to said request.

In one embodiment the register is a Visitor Location Register, and/or said non-mobile terminal is a PSTN terminal, and/or said message is an ISUP message.

According to the present invention, there is also provided a computer program product comprising computer program code which when loaded onto a computer configures the computer to perform the above method.

According to the present invention, there is also provided a device configured to: receive a message regarding the initiation of a session at a non-mobile terminal; make a request for subscriber profile information for said non-mobile terminal to a register that is also configured to receive requests for subscriber profile information for mobile terminals; and to control said session on the basis of subscriber profile information for said non-mobile terminal received in reply to said request.

In one embodiment, the device is a switching unit of a mobile network, and/or said message is an ISUP message.

According to the present invention, there is also provided a method, comprising receiving a request for subscriber profile information; and determining whether the request relates to subscriber profile information for a non-mobile terminal or subscriber profile information for a mobile terminal.

In one embodiment, said request is from a switching unit of a mobile network.

In one embodiment, the method comprises querying a first database if the request relates to subscriber profile information for a non-mobile terminal; and querying a second database if the request relates to subscriber profile information for a mobile terminal. The second database may be a Home Location Register (HLR), and/or the first database may be a centralised subscription repository also accessible by control entities of a plurality of networks.

The querying of said first database may be carried out in accordance with a LDAP protocol, and/or the querying of said second database may carried out in accordance with a MAP protocol.

According to the present invention, there is also provided a computer program product comprising computer program code which when loaded onto a computer configures the computer to perform the above method.

According to the present invention, there is also provided a device configured to: receive a request for subscriber profile information; and to determine whether the request relates to subscriber profile information for a non-mobile terminal or subscriber profile information for a mobile terminal.

In one embodiment, the device is further configured to query a first database if the request relates to subscriber profile information for a non-mobile terminal; and to query a second database if the request relates to subscriber profile information for a mobile terminal, and/or the device is a Visitor Location Register.

According to the present invention, there is also provided a method comprising: providing a store of subscriber profile information for both non-mobile terminals and mobile terminals; and providing subscriber profile information for a non-mobile terminal in reply to a request for such subscriber profile information from an entity that is also configured to make requests for subscriber profile information for mobile terminals.

In one embodiment, said entity is a Visitor Location Register, and/or said non-mobile terminal is a PSTN terminal.

According to the present invention, there is also provided a computer program product comprising computer program code which when loaded onto a computer configures the computer to perform the above method.

According to the present invention, there is also provided a device configured to store subscriber profile information for both non-mobile terminals and mobile terminals; and to receive requests for said subscriber profile information for non-mobile terminals from an entity that is also configured to make requests for subscriber profile information for mobile terminals.

In one embodiment, the device is configured to store said subscriber profile information for mobile terminals as a back-up to a Home Location Register, and which is accessible by said Home Location Register, and/or is a centralised subscription repository that is accessible by control entities of a plurality of networks.

According to the present invention, there is also provided a system comprising: a first device configured to: receive messages regarding the initiation of sessions at both non-mobile terminals and mobile terminals, and make requests for subscriber profile information for said sessions; a second device configured to receive requests for subscriber profile information for both non-mobile terminals and mobile terminals from said first device, to determine whether each request relates to subscriber profile information for a non-mobile terminal or subscriber profile information for a mobile terminal; and a third device configured to store subscriber profile information for both non-mobile terminals and mobile terminals, and to provide subscriber profile information for a non-mobile terminal in reply to a request from said second device; and wherein the first device is also configured to control each of said sessions on the basis of the respective subscriber profile information.

In one embodiment, the first device is a switching unit of a mobile network, and/or the second device is a VLR, and/or the third device is a centralised subscription repository.

According to the present invention, there is also provided a device, comprising: means for receiving a message regarding the initiation of a session at a non-mobile terminal; means for making a request for subscriber profile information for said non-mobile terminal to a register that is also configured to receive requests for subscriber profile information for mobile terminals; and means for controlling said session on the basis of subscriber profile information for said non-mobile terminal received in reply to said request.

According to the present invention, there is also provided a device, comprising: means for receiving a request for subscriber profile information; and means for determining whether the request relates to subscriber profile information for a non-mobile terminal or subscriber profile information for a mobile terminal.

According to the present invention, there is also provided a device, comprising: means for storing subscriber profile information for both non-mobile terminals and mobile terminals; and means for receiving requests for said subscriber profile information for non-mobile terminals from an entity that is also configured to make requests for subscriber profile information for mobile terminals.

Embodiments of the present invention are described in detail hereunder, by way of example only, with reference to the accompanying drawings, in which:

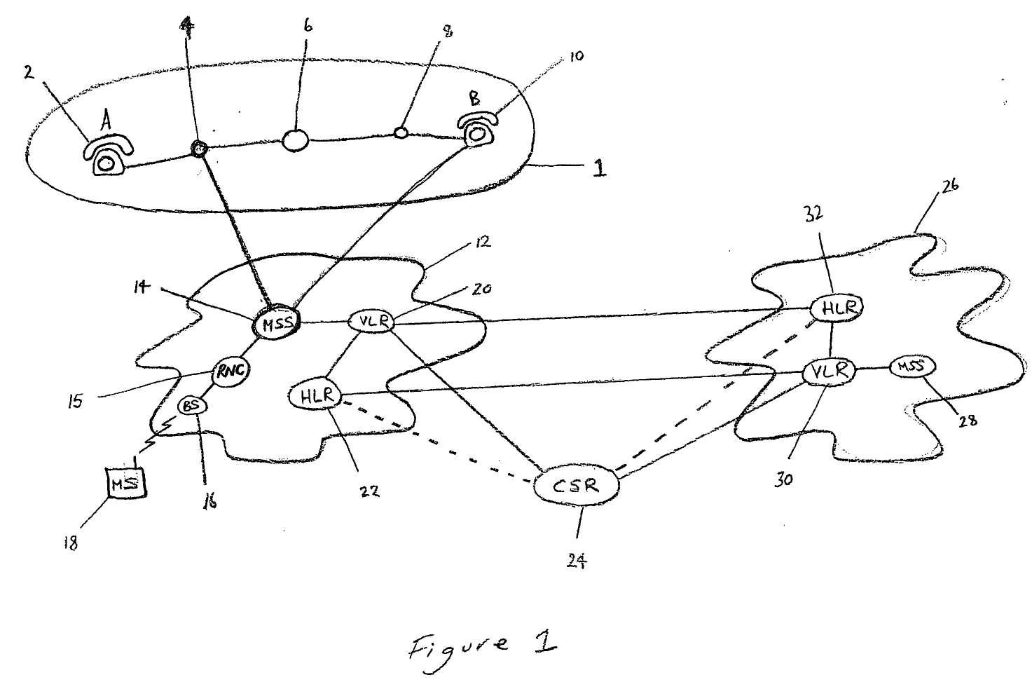

FIG. 1 illustrates an example of system architecture used in an embodiment of the present invention;

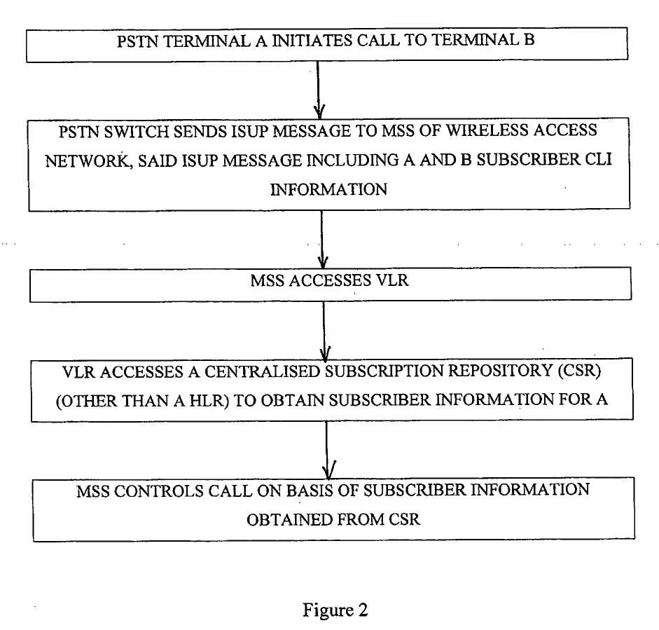

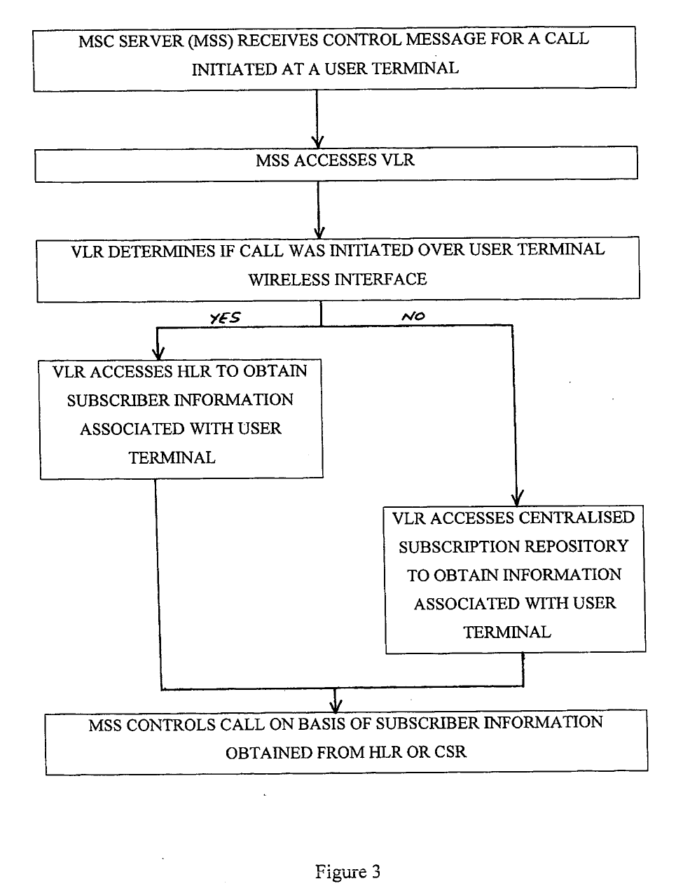

FIGS. 2 and 3 illustrate the combined operation of a MSS, VLR and CSR according to an embodiment of the present invention;

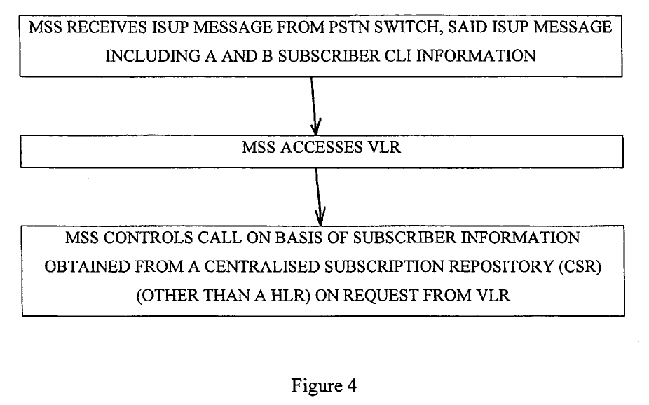

FIG. 4 illustrates the operation of an MSS according to an embodiment of the present invention.

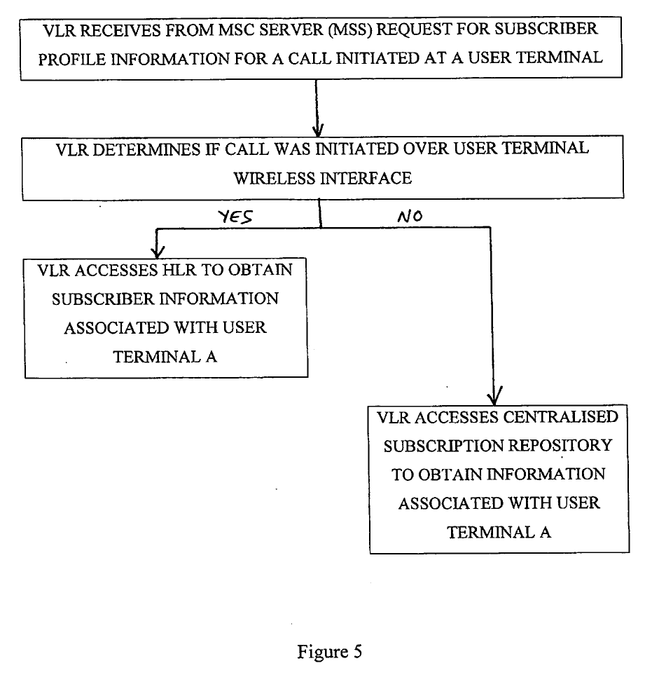

FIG. 5 illustrates the operation of a VLR according to an embodiment of the present invention; and

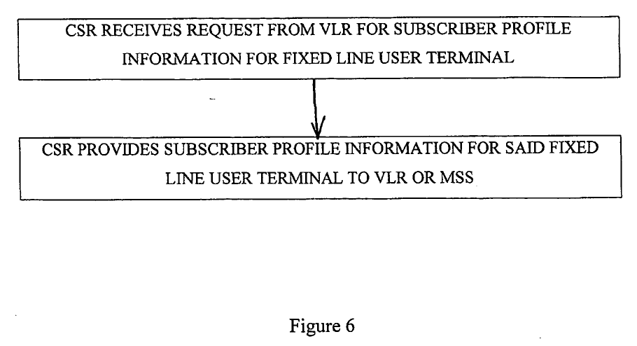

FIG. 6 illustrates the operation of a CSR according to an embodiment of the present invention.

With reference to FIG. 1, an embodiment of the present invention will be described, by way of example only, for a case where user terminal A 2 of a public switched telephone network (PSTN) 1 initiates a call to another user terminal B 10 of the PSTN 1. However, the same technique is also applicable to other types of sessions, such as (a) calls to user terminals outside of the PSTN 1, such as mobile terminals associated with either of the mobile networks 12, 26 illustrated in FIG. 1; or (b) sessions with remote servers providing information or services.

Conventionally, a call between user terminals A and B is conducted via one or more PSTN switches/telephone exchanges 4, 6, 8.

According to one embodiment of the present invention, the switching is instead carried out at a switching unit (such as a MSC Server (MSS)) 14 of a mobile network 12. The mobile network 12 includes a number of base stations (eNodeBs) 16 (although only one is shown in FIG. 1) under the control of the MSS 14 via a Radio Network Controller (RNC) 15. One of the functions of the MSS 14 is to handle call control and signalling for calls initiated over wireless interfaces between mobile stations (MS) 18 and base stations (eNodeBs) 16 of the mobile network 12. The mobile station is identified independently of the point of access and of the wireless parameters (such as frequency, time etc.). In more detail, the mobile station is identified by a SIM number which is used to identify the mobile station for initiating sessions via wireless connections with different base stations and at different frequencies. The call control involves accessing a Visitor Location Register (VLR) 20 associated with the mobile network 12. If the mobile network 12 is the home network for the mobile station 2, the VLR accesses the Home Location Register (HLR) 22 associated with the mobile network 12. If another mobile network is the home network for the mobile station 2, the VLR 20 accesses the Home Location Register (HLR) 22 associated with said another network. For example, if the second mobile network 26 is the home network for the mobile stations 2, the VLR 20 accesses the HLR 32 for the second mobile network 26. The second mobile network 26 operates in the same way for calls initiated over a wireless interface between a mobile station (not shown) and a base station (not shown) of the second mobile network 26. In detail, it also includes a MSS 28 and a VLR 30, which operate in the same way as those of the first mobile network 12.

In this embodiment of the invention, the PSTN switch 4 is reconfigured such that it works in proxy mode whereby all calls are routed to the next switching level. In detail, the PSTN switch 4 sends an ISDN User Part (ISUP) message to MSS 14, which message includes Calling Line Identification (CLI) information for user terminals A and B. The MSS 14 then accesses the VLR 20, and the VLR 20 accesses a central subscription repository (CSR) 24 according to the Lightweight Directory Access Protocol (LDAP). The central subscription repository 24 stores subscriber profile information for a plurality of PSTN user terminals including user terminal A, and is also accessible by the VLRs of one or more other mobile networks such as the second mobile network 26 shown in FIG. 1. The subscriber profile information stored in the CSR for the plurality of PSTN user terminals includes the same kind of basic supplementary service information that would be stored in a Home Location Register and would also be relevant to calls initiated at PSTN user terminals. Information that is not relevant to calls initiated at PSTN user terminals would be omitted, such as mobility management information and SMS information.

The CSR 24 also serves as a back-up to HLR 22 and HLR 24 by storing the same roaming user terminal subscriber profile information that is stored at HLR 22 or HLR 32. Subscriber profile information for a non-active subscriber that may be temporarily deleted from HLR 22 or HLR 32 is retained at CSR 24, from which it can be restored to HLR 22 or HLR 32 when the subscriber becomes active again. The dotted lines between CSR 24 and HLR 22 and between CSR 24 and HLR 32 indicate a logical connection between these entities.

In the way described above, the VLR 20 fetches directly from the CSR 24 the necessary subscriber profile information required for controlling the call initiated by user terminal A.

The MSS then controls the call initiated at user terminal A on the basis of the subscriber information obtained from the CSR 24 via the VLR 20, and in substantially the same way that it would do for forwarding calls initiated at mobile terminals.

The combined operation of the MSS, VLR and CSR is illustrated in FIGS. 2 and 3. The respective operations of the MSS, VLR and CSR are illustrated in FIGS. 4, 5 and 6, respectively. In summary, the MSS receives a control message for a call initiated at a user terminal and accesses the VLR for detailed subscriber data for the user terminal. The VLR gets slightly different subscriber identification information from the MSS depending on whether the user terminal is a non-mobile terminal or a mobile terminal. For a mobile terminal, the MSS provides a Subscriber Identity Module (SIM) identification (International Mobile Subscriber Identity (IMSI)) to the VLR whereas for a non-mobile terminal, the MSS provides a line identification. Depending on whether the user terminal is determined (on the basis of the information from the MSS) by the VLR to be (i) a mobile terminal or (ii) a fixed terminal, the VLR either (i) fetches detailed subscriber data from the HLR with Mobile Access Protocol (MAP), or (ii) fetches detailed subscriber data from the CSR with Lightweight Directory Access Protocol (LDAP) or other appropriate protocol. The MSS then controls the call on the basis of the detailed subscriber data obtained from the HLR or CSR.

The VLR 20 may be part of the MSS 14.

With the above-described embodiment, the calls initiated at PSTN user terminals can be handled by a switching unit (such as an MSS) of a mobile network, even though no location update is normally made for such user terminals. The MSS 14 is configured such that it can handle any such call from a PSTN subscriber whilst supporting some or all of the Class 5 features supported by a PSTN Class 5 Switch.

In order to implement the above-described embodiment, a conventional MSS, VLR and CSR are provided with additional new functionality. The MSS is modified so as to (a) support the receipt and processing of ISUP messages and (b) support any of the additional PSTN Class 5 features that are desired. The VLR is modified so as to (a) provide the logic function of determining if a call is initiated at a mobile or non-mobile terminal based on the subscriber identification information received from the MSS; (b) have the capability to access the CSR with LDAP; and (c) map detailed subscriber data from the CSR into signalling towards the MSS. For the latter, where the MSS and the VLR are integrated, such signalling is not visible outside the MSS/VLR. The CSR is modified so as support the provision of detailed subscriber data for non-mobile terminals to the VLR. Regarding the PSTN switch, it is sufficient to reconfigure the existing functionality of the PSTN switch such that call information is directed to the MSS instead of another PSTN switch.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

1. A method comprising: receiving a message regarding the initiation of a session from a non-mobile terminal; making a request for subscriber profile information for said non-mobile terminal to a register that is also configured to receive requests for subscriber profile information for mobile terminals; and controlling said session on the basis of subscriber profile information for said non-mobile terminal received in reply to said request.

2. A method according to claim 1, wherein the register is a Visitor Location Register.

3. A method according to claim 1, wherein said non-mobile terminal is a PSTN terminal.

4. A method according to claim 1, wherein said message is an ISUP message.

5. A device configured to: receive a message regarding the initiation of a session at a non-mobile terminal; make a request for subscriber profile information for said non-mobile terminal to a register that is also configured to receive requests for subscriber profile information for mobile terminals; and to control said session on the basis of subscriber profile information for said non-mobile terminal received in reply to said request.

6. A device according to claim 5, which is a switching unit of a mobile network.

7. A device according to claim 4, wherein said message is an ISUP message.

8. A computer program product comprising computer program code which when loaded onto a computer configures the computer to perform the method of any of claim 1.

9. A method, comprising receiving a request for subscriber profile information; and determining whether the request relates to subscriber profile information for a non-mobile terminal or subscriber profile information for a mobile terminal.

10. A method according to claim 9 wherein said request is from a switching unit of a mobile network.

11. A method according to claim 9, comprising querying a first database if the request relates to subscriber profile information for a non-mobile terminal; and querying a second database if the request relates to subscriber profile information for a mobile terminal.

12. A method according to claim 11, wherein the second database is a Home Location Register (HLR).

13. A method according to claim 11, wherein said first database is a centralised subscription repository also accessible by control entities of a plurality of networks.

14. A method according to claim 11, wherein said querying said first database is carried out in accordance with a LDAP protocol.

15. A method according to claim 11, wherein said querying said second database is carried out in accordance with a MAP protocol.

16. A device configured to: receive a request for subscriber profile information; and to determine whether the request relates to subscriber profile information for a non-mobile terminal or subscriber profile information for a mobile terminal.

17. A device according to claim 16, which is further configured to query a first database if the request relates to subscriber profile information for a non-mobile terminal; and to query a second database if the request relates to subscriber profile information for a mobile terminal.

18. A device according to claim 16, which is a Visitor Location Register.

19. A computer program product comprising computer program code which when loaded onto a computer configures the computer to perform the method of any of claim 9.

20. A method comprising: providing a store of subscriber profile information for both non-mobile terminals and mobile terminals; and providing subscriber profile information for a non-mobile terminal in reply to a request for such subscriber profile information from an entity that is also configured to make requests for subscriber profile information for mobile terminals.

21. A method according to claim 20, wherein said entity is a Visitor Location Register.

22. A method according to claim 20, wherein said non-mobile terminal is a PSTN terminal.

23. A device configured to store subscriber profile information for both non-mobile terminals and mobile terminals; and to receive requests for said subscriber profile information for non-mobile terminals from an entity that is also configured to make requests for subscriber profile information for mobile terminals.

24. A device according to claim 23, which is configured to store said subscriber profile information for mobile terminals as a back-up to a Home Location Register, and which is accessible by said Home Location Register.

25. A device according to claims 23, which is a centralised subscription repository that is accessible by control entities of a plurality of networks.

26. A computer program product comprising computer program code which when loaded onto a computer configures the computer to perform the method of claim 20.

27. A system comprising:
a first device configured to: receive messages regarding the initiation of sessions at both non-mobile terminals and mobile terminals, and make requests for subscriber profile information for said sessions;
a second device configured to receive requests for subscriber profile information for both non-mobile terminals and mobile terminals from said first device, to determine whether each request relates to subscriber profile information for a non-mobile terminal or subscriber profile information for a mobile terminal; and
a third device configured to store subscriber profile information for both non-mobile terminals and mobile terminals, and to provide subscriber profile information for a non-mobile terminal in reply to a request from said second device;
and wherein the first device is also configured to control each of said sessions on the basis of the respective subscriber profile information.

28. A system according to claim 27, wherein the first device is a switching unit of a mobile network.

29. A system according to claim 27, wherein the second device is a VLR.

30. A system according to claim 27, wherein the third device is a centralised subscription repository.

31. A device, comprising:
means for receiving a message regarding the initiation of a session at a non-mobile terminal;
means for making a request for subscriber profile information for said non-mobile terminal to a register that is also configured to receive requests for subscriber profile information for mobile terminals; and
means for controlling said session on the basis of subscriber profile information for said non-mobile terminal received in reply to said request.

32. A device, comprising:
means for receiving a request for subscriber profile information; and
means for determining whether the request relates to subscriber profile information for a non-mobile terminal or subscriber profile information for a mobile terminal.

33. A device, comprising:
means for storing subscriber profile information for both non-mobile terminals and mobile terminals; and
means for receiving requests for said subscriber profile information for non-mobile terminals from an entity that is also configured to make requests for subscriber profile information for mobile terminals.
